(19) United States
(12) Patent Application Publication
(10) Pub. No.: US 2026/0339425 A1
(43) Pub. Date: Oct. 29, 2026

(54) AUTO SCREEN CONTROL FOR DISPLAYS AND OTHER DEVICES

(71) Applicant: DISH Network Technologies India Private Limited, Bengaluru (IN)

(72) Inventors: Srinivasarao Duddu, Bangalore (IN); Ananda Siddappa, Bangalore (IN)

(73) Assignee: DISH Network Technologies India Private Limited, Bengaluru (IN)

(21) Appl. No.: 19/657,537

(22) Filed: Apr. 24, 2026

(30) Foreign Application Priority Data
Apr. 25, 2025 (IN) 202541040299

(51) Int. Cl. G06F 3/01; G06F 3/16; H04N 21/414; H04N 21/442

(52) U.S. Cl. CPC G06F 3/011; G06F 3/017; G06F 3/165; H04N 21/41415; H04N 21/44218

(57) ABSTRACT

An example process includes the steps of monitoring a location with a radar device, detecting a human presence in the monitored location using the radar device, and transmitting first data indicating the human presence in the monitored location from the radar device and to a playback device. A first instruction is sent from the playback device to a display in response to the human presence. The radar device detects a lack of the human presence in the monitored location and transmits second data indicating the lack of human presence in the monitored location to the playback device. A second instruction is sent from the playback device to the display in response to the lack of human presence.

### CROSS REFERENCE TO RELATED APPLICATIONS

The following application claims priority to Indian Provisional Application No. 202541040299 filed on Apr. 25, 2025 and entitled “AUTO SCREEN CONTROL FOR DISPLAYS AND OTHER DEVICES,” which is incorporated in its entirety herein by reference.

### TECHNICAL FIELD

The following generally relates to automated control of screens and displays.

### BACKGROUND

Televisions, digital billboards, and other stationary screens can be turned on for long periods in public places. Digital billboards, for example, can remain powered on indefinitely. Televisions or digital displays in shopping centers can remain on during business hours. Displays in common areas of houses similarly are often left on for long periods of time. In each of these examples, the displays are sometimes left on when nobody is present to view them.

Leaving TVs, digital billboards, and digital displays on when no one is watching can result in energy waste, and can drive up electricity costs. Any excess energy use can contribute to unnecessary carbon emissions, especially if the energy comes from non-renewable sources. The continuous use of these display devices also shortens their lifespans, increasing maintenance costs and contributing to more electronic waste. Moreover, leaving displays on without an audience can create visual clutter, which harms the aesthetics of public spaces and contributes to light pollution. Unwanted light can disrupt sleep patterns or otherwise interrupt a dark night sky.

### SUMMARY

Systems, processes, and devices for monitoring spaces and adapting displays based on human presence are disclosed herein. One example process includes the steps of monitoring a location with a radar device, detecting a human presence in the monitored location using the radar device, and transmitting first data indicating the human presence in the monitored location from the radar device and to a playback device. A first instruction is sent from the playback device to a display in response to the human presence. The radar device detects a lack of the human presence in the monitored location and transmits second data indicating the lack of human presence in the monitored location to the playback device. A second instruction is sent from the playback device to the display in response to the lack of human presence.

In various embodiments, the first instruction comprises an instruction to turn on the display. The second instruction comprises an instruction to turn off the display. The playback device comprises a set-top box. The display comprises a billboard. The radar device comprises a 24- GHz wavelength (mmWave) device. The radar device transmits electromagnetic waves and receives reflections of the electromagnetic waves to monitor the location. A gesture can be detected in the monitored location using the radar device, and third data indicating detection of the gesture in the monitored location is transmitted to the playback device. A third instruction may be sent from the playback device to the display to adjust a playback volume in response to the gesture.

In another example process, a road is monitored with a radar device. The radar device may detect a presence of an automobile moving towards a billboard on the monitored road. First data indicating the presence of the automobile moving towards the billboard on the monitored road is transmitted to a computing device, and the computing device changes a state of the billboard in response to receiving the first data.

In various embodiments, the computing device changes the state of the billboard to illuminated in response to receiving the first data. The example process can include the steps of detecting a second automobile moving away from the billboard on the monitored road, transmitting second data indicating the second automobile is moving away from the billboard on the monitored road, and changing the state of the billboard in response to receiving the second data. Steps can include detecting the automobile has left a field of view (FOV), transmitting second data indicating the automobile has left the field of view, and changing the state of the billboard in response to receiving the second data. The state of the billboard may be changed in response to receiving the second data comprises darkening the billboard. A screen may be selected for display on the billboard in response to a detected speed of the automobile moving towards the billboard.

In still another example process, a location may have a first radar device with a first field of view (FOV) oriented towards the location and a second radar device with a second FOV oriented towards the location. The process may include the steps of detecting a human presence in the first FOV using the first radar device, transmitting first data indicating the human presence in the first FOV from the radar device, and sending a first instruction to a first display in response to the human presence in the first FOV. The radar devices can detect a lack of human presence in the first FOV and the human presence in the second FOV. Second data indicating the lack of human presence in the first FOV can be transmitted from the first radar device. A second instruction is sent to the first display in response to the lack of human presence in the first FOV. The second radar device transmits third data indicating the human presence in the second FOV, and a third instruction is sent to a second display in response to the human presence in the second FOV.

In various embodiments, the first FOV penetrates a wall to detect the human presence in the monitored location. The second FOV is oriented downward and comprises a beamwidth from 5 degrees to 30 degrees. The monitored location comprises a walkway. The first portion of the walkway monitored by the first FOV is adjacent a second portion of the walkway monitored by the second FOV. The first FOV overlaps with the second FOV.

### BRIEF DESCRIPTION OF THE DRAWINGS

FIG. 1A illustrates a top view of a wall-based system for controlling a display, in accordance with various embodiments.

FIG. 1B illustrates a side view of a wall-based system for controlling a display, in accordance with various embodiments.

FIG. 2 illustrates a side view of a ceiling-based system for controlling a display, in accordance with various embodiments.

FIG. 3 illustrates a system for controlling a digital billboard, in accordance with various embodiments.

FIG. 4 illustrates a system for controlling displays along a public walkway, in accordance with various embodiments.

FIG. 5 illustrates a process for controlling displays, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description. The detailed description refers to the accompanying drawings, which show such embodiments by way of illustration. While these embodiments are described in sufficient detail to enable those skilled in the art to practice the inventions, it should be understood that other embodiments may be realized, and that logical and mechanical changes may be made without departing from the spirit and scope of the inventions. The detailed description herein is thus presented for purposes of illustration only and not of limitation. For example, the steps recited in any of the method or process descriptions may be executed in any order and are not necessarily limited to the order presented.

Systems, methods, and devices of the present disclosure can use reflection of energy waves to detect movement. Some examples can use radar technology at higher frequencies than traditional radar systems. Examples of suitable radar frequencies can range from 20 GHz to 300 GHz. In one example, 24GHz mmWave sensors can detect human bodies in a living room or walkway enabling control an associated display. The mmWave device can be paired with a set-top box (STB) or other computing device, and the STB can send control signals to the display based on detected motion or the lack of detected motion in association with timers and timing thresholds. The displays or content can be paused, played, turned off, turned on, attenuated, resumed, adjusted, dimmed, brightened, or otherwise controlled in response to detection of a person in a monitored area. Monitoring in public areas with radar technologies also tends to alleviate privacy concerns that can arise when monitoring with cameras.

In addition to commonly used displays, other electronic devices controlled based on location of nearby people can include digital billboards, digital menus, air fresheners, air purifiers, humidifiers, air conditioning units, heaters, coffee machines, STBS, or other electronic device can be controlled based on distance from or location of a human in conjunction with other inputs such as time, for example. Radar monitoring may be used in senior living communities, hotels, or other public places to detect the movement of people and control electronics.

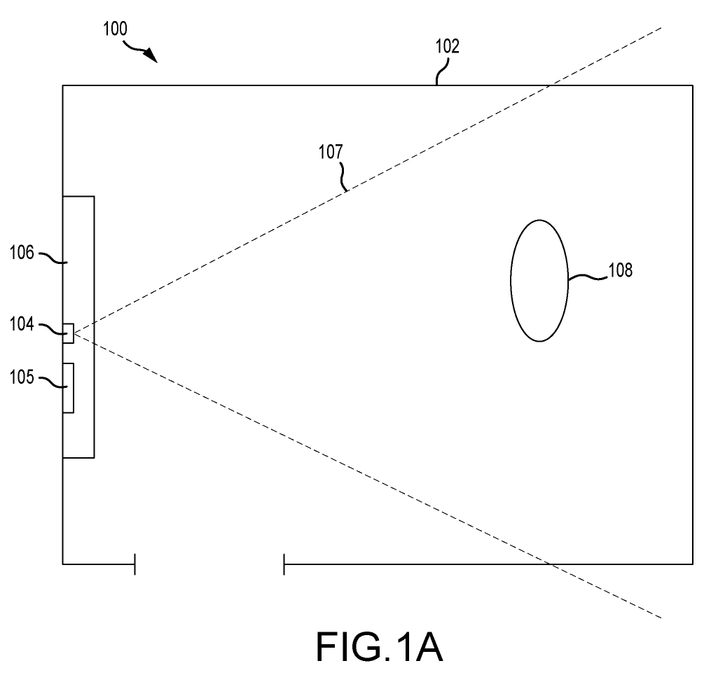

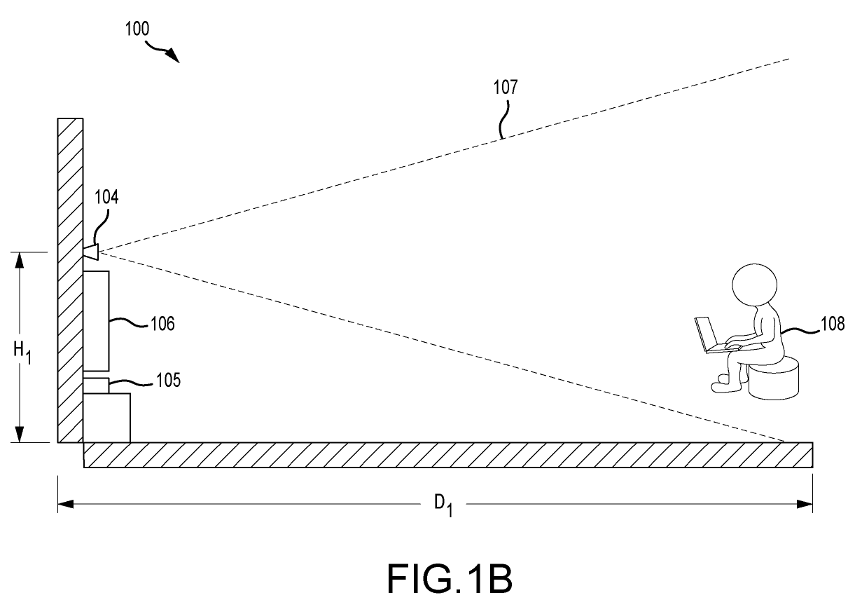

Turning now to the figures and with initial reference to FIGS. 1A and 1B, an example system 100 for controlling electronic devices is shown, in accordance with various embodiments. System 100 comprises a room 102 in the example of FIG. 1A, though the device controlling components and techniques described herein can be applied outdoors, in vehicles, in warehouses, or in other venues or spaces that may not include room 102. Room 102 can include radar device 104 coupled to a wall.

In various embodiments, radar device 104 can comprise an mmWave device. In one example, radar device 104 can comprise a 24GHz mmWave device. MmWave devices can use frequency-modulated continuous waves (FMCW) to detect human targets in room 102. Combined with radar signal processing and precise human body sensing algorithms, radar device 104 may be configured to detect human presence with high-sensitivity. Radar device 104 can identify human bodies and distinguish between bodies in motion or stationary. And auxiliary information such as the distance of the target can be calculated. This product is mainly used in indoor scenes to sense whether there is a moving or micro-moving human body in the area, and output the detection results in real time.

In some examples, radar device 104 can be a computing device in various embodiments. Computing devices described herein may include a processor in electronic communication with non-transitory memory. The memory may be configured to store operations thereon that, when executed by the processor, cause system 100 to perform operations. In some examples, radar device 104 may include wireless communication capabilities over Bluetooth®, WiFi®, or other wireless communication techniques. Radar device can equivalently be configured for wired communication with a computing device 105. Radar device 104 may be in wireless communication with computing device 105, and computing device 105 can use information from radar device 104 to make control decisions. For example, radar device 104 may transmit a signal to a STB indicating a person 108 has entered room 102, and the STB may turn on display 106 in response to the signal. Computing device 105 can comprise an Internet of Things (IoT) device, a smart TV, an STB, a set-back box (SBB), a computer, a laptop, a smartphone, a display, or any other electronic device capable of communication with radar device 104.

In various embodiments, multiple radar devices 104 can be integrated into a room 102, a house, or other suitable space. Multiple radar devices 104 deployed in a single space can be used to detect the presence of multiple people as they move across the space. The human locations and movements may be used to control IoT devices and displays based on the movement of people in the space.

In an example using 24 GHz mmWave devices as radar devices 104, high-frequency electromagnetic waves are emitted by the device and travel through room 102. When these waves encounter objects, they are partially reflected back to radar device 104. Human bodies, in particular, reflect these signals due to their size, shape, and properties. This interaction between the emitted waves and the human body enables good detection of human presence.

Radar device 104 can include a receiver that captures the reflected electromagnetic signals. By measuring the time it takes for the waves to return, along with changes in the signal's frequency caused by the Doppler effect, the device can estimate the distance and movement of objects in its environment. Because humans reflect these signals in a unique way compared to other objects, the device can specifically detect human presence and track their movements.

The reflected signals may be processed by the device's onboard sensors and algorithms. These systems analyze the phase, frequency, and time-of-flight of the signals to build a picture of the space and any objects within it. With this data, the system can detect not only the presence of a person but also their position, movement, and sometimes even gestures or posture. This makes mmWave sensors particularly effective when deployed as radar device 104 in system 100.

In some embodiments, radar device 104 using mmWave can detect motion and human presence even through materials such as walls or furniture. Unlike optical or infrared sensors, mmWave waves can pass through obstacles, allowing the device to monitor a space without line-of-sight. This makes mmWave sensors versatile in complex environments, where traditional sensors might struggle to detect human presence.

System 100 can take any number of actions in response to detecting motion, presence, or gestures of humans in room 102. For example, computing device 105 can dim, mute, attenuate, turn off, or otherwise change the operating state of display 106 in response to detecting person 108 is leaving room 102. In another example, computing device 105 can brighten, unmute, turn up, turn on, or otherwise change the operating state of display 106 in response to detecting person 108 is entering room 102 or present in room 102.

In various embodiments, system 100 can be configured to take action in response to detection of human movement or presence in addition to secondary factors. For example, computing device 105 can instruct display 106 to turn on in response to detecting person 108 in room 102 and in response to the time being between 7:00 am and 6:00 pm. In another example, computing device 105 can instruct display 106 to turn on in response to detecting person 108 in room 102 and in response to the last signal from a remote control being a power-on signal directed to display 106. In still another example, computing device 105 can instruct display 106 to turn on in response to detecting person 108 in room 102 and in response to a preselected live television program (e.g., a sports game or other live broadcast) airing.

In some embodiments, computing device 105 can control other devices capable of electronic communication with computing device 105. For example, computing device 105 can instruct a coffee machine to begin making coffee in response to the first time it detects human movement in room 102 after 6:00 am. In some examples, the coffee machine can include its own integrated computing device in communication radar device 104 to take action in response to detecting human movement in room 102.

Radar device 104 can be selectively mounted in a location to aim or point field-of-view (FOV) 107. FOV 107 can comprise an angular component that determines the width and height FOV 107. FOV 107 can vary based on antenna design, the radar's beamwidth, and the configuration of radar device 104.

In various embodiments, the horizontal beamwidth can range from approximately 5° to approximately 30°. As used herein with numeric values, the term approximately may mean within a range of +/- 5%, +/- 10%, +/- 15%, +/- 20%, or +/- 25%. Examples of radar device 104 using a wider beam can allow the device to cover a larger area. The vertical beamwidth can be narrower than the horizontal beamwidth in some embodiments. For example, the vertical beamwidth can range from approximately 5° to approximately 15°. These beamwidths influence the radar's FOV. A narrower beam tends to have finer resolution and cover a smaller area. Radar device 104 can have a detection range from approximately 5 meters (m) to approximately 200 m.

In some examples, the horizontal FoV can range from approximately 30 degrees to approximately 90 degrees, and the vertical FoV can range between approximately 10° and approximately 30°. The radar’s resolution can be determined by its beamwidth and frequency, with high-frequency 24 GHz mmWave radar offering fine resolution to detect smaller or closely spaced objects. Angular resolution can range from approximately 1 degree to approximately 5 degrees, allowing the radar to distinguish fine details of human presence or movement within its FoV.

Radar device 104 can be tuned to room 102 or another space by selecting a radar device 104 having desired range and FOV characteristics. Radar device 104 can be coupled to a wall of room 102 in various examples. In the example of FIGS. 1A and 1B, radar device 104 is on a wall adjacent computing device 105 and display 106, though the various components of system 100 can be spread throughout a space such as room 102 and need not be proximate one another to function as described herein. Radar device 104 can be mounted at height H1 above the ground in room 102. Height H1 can range from approximately 1 m to approximately 2 m in some examples, though other mounting heights could be equivalently used. Radar device 104 can be mounted at an angle to appropriately aim its FOV 107 at the desired location in room 102 for monitoring. A field of view of radar device 104 can extend a distance D1 from the radar device.

In various embodiments, radar device 104 may be aimed at a downward angle when mounted near the top of a wall to target FOV 107 at the area to be monitored for people 108. Radar device 104 may be aimed at an upward angle when mounted near the bottom of a wall to target FOV 107 at the area to be monitored for people 108, though higher mounting points may tend to reduce obstruction and improve detective capabilities of radar device 104. Various embodiments can use different mounting locations, surfaces, and support structures for radar device 104.

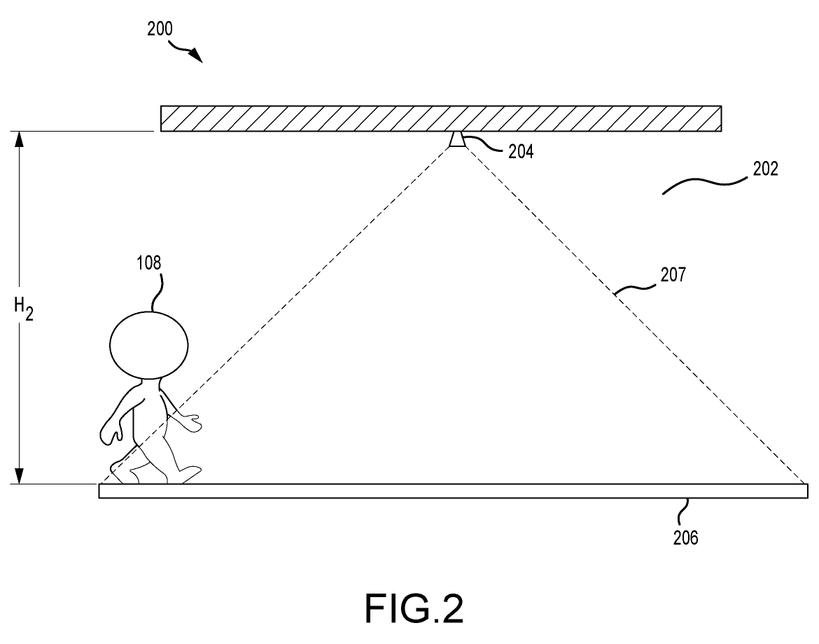

Referring now to FIG. 2, system 200 is shown for controlling electronic devices, in accordance with various embodiments. System 200 can be similar to system 100 of FIGS. 1A and 1B and can include a ceiling-mounted radar device 204 monitoring space 202. Ceiling-mounted radar device 204 can be arranged to monitor an area of floor 206 in field of view 207.

In various embodiments, radar device 204 can detect person 108 and wirelessly transmit detection data to computing devices to take appropriate actions in response to human presence or movement. Radar device 204 can be mounted at a height H2 above floor 206. In a typical room, height H2 can be approximately 8 feet. In larger spaces or walkways, height H2 can range from approximately 6 feet to approximately 12 feet. In some examples, vaulted ceilings can raise height H2 farther than 12 feet from floor 206. Increasing height H2 tends to increase the area on floor 206 within FOV 207 of radar device 204.

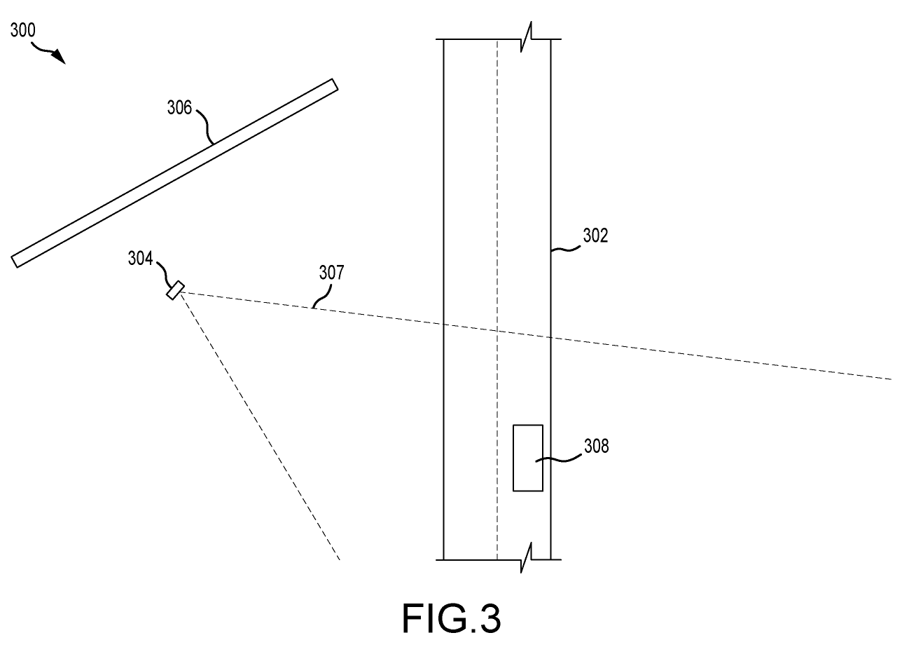

With reference to FIG. 3, system 300 is shown for controlling billboard 306, in accordance with various embodiments. Billboard 306 can comprise a digital billboard controlled by a computing device in communication with radar device 304, though traditional billboards can also comprise lighting controllable in response to signals from radar device 304. Some billboards can select advertisements or information to display using selectable screens for display on the billboard in response to data from a radar device. For example, a digital billboard or marquee can display a message for a speeding driver in response to determining an automobile is moving over the speed limit by a threshold value. In a similar example, a digital billboard or marquee can display a message for a safe driver in response to determining an automobile is moving within a threshold value of the speed limit.

In various embodiments, radar device 304 can be coupled to a post, pole, mast, or other support structure alongside road 302. Radar device 304 can be oriented with FOV 307 angled toward the road and configured to detect travel of vehicle 308 towards billboard 306. Radar device 304 can detect direction of travel of automobile 308 along road 302. For example, radar device 304 can detect frequency changes in the return signal in response to the doppler effect, and the frequency changes can indicate the direction of travel of vehicle 308 along road 302.

Radar device 304 can be mounted along roadside at a desired distance ahead of billboard 306 to trigger actions in response to the vehicle approaching. In some examples, radar device 304 can be positioned approximately 250 m, approximately 500m, approximately 750m, or approximately 1,000 m ahead of billboard 306 alongside road 302. In response to detecting oncoming vehicle 308, billboard 306 can turn on if digital or lights illuminating billboard 306 can turn on if traditional. A computing device can be in wired or wireless communication with radar device 304, and the computing device can issue control signals to billboard 306. Billboard 306 can remain illuminated for a predetermined illumination duration in response to detecting an oncoming vehicle. For example, billboard 306 can remain illuminated for 30 seconds, 1 minute, 2 minutes, 5 minutes, or any desired duration in response to detecting an oncoming vehicle. Billboard 306 can reset its illumination period in response to detecting another oncoming vehicle 308 before the predetermined illumination duration has expired. In some embodiments, outgoing traffic can be detected and differentiated from oncoming traffic, and billboard 306 can remain dark in response to detecting only outgoing traffic.

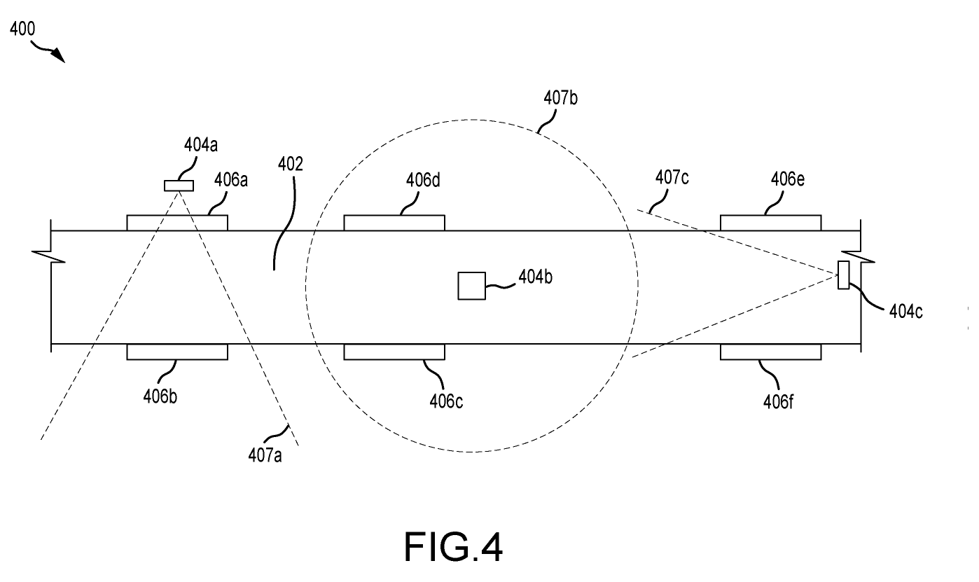

Referring now to FIG. 4, system 400 is shown for controlling displays 406a-406f along walkway 402, in accordance with various embodiments. System 400 may include radar device 404a coupled to, in front of, or behind a wall or other object. Radar device can have FOV 407a extending across walkway 402. Human detection data from radar device 404a can be used to control on/off status of display device 406a or display device 406b. Human detection data from radar device 404a can be used in conjunction with human detection data from other radar devices to control various display devices along walkway 402.

System 400 may include radar device 404b coupled over, beneath, or to the ceiling or another object. Radar device 404b can have FOV 407b extending downward onto walkway 402. Human detection data from radar device 404b can be used to control on/off status of display device 406c or display device 406d. Human detection data from radar device 404b can be used in conjunction with human detection data from radar device 404a or other radar devices to control various display devices along walkway 402.

System 400 may include radar device 404c coupled to, in front of, or behind a wall or other object. Radar device can have FOV 407c extending along walkway 402. Human detection data from radar device 404c can be used to control on/off status of display device 406e or display device 406f. Human detection data from radar device 404c can be used in conjunction with human detection data from other radar devices to control various display devices along walkway 402.

In various embodiments, a computing device can coordinate control of displays 406a-406f based at least in part on human detection data from radar devices 404a-404c. For example, a computing device can send on commands to displays 406a and 406b in response to a human entering field of view 407a. The computing device can send off commands to displays 406a and 406b in response to a human exiting field of view 407a. An off timer can be used so that the computing device can send off commands to displays 406a and 406b in response to a human having left field of view 407a for a predetermined delay duration.

In some examples, the computing device can send off commands to or start delay timers for displays 406a and 406b in response to a human entering field of view 407b of the next radar device 404b along walkway 402. The computing device can send on commands to displays 406c and 406d in response to a human entering field of view 407b of radar device 404b. The computing device can similarly send commands based in whole or in part on human detection data from radar device 404c. Displays 406a-406f can thus turn on as humans approach and off as humans depart the adjacent regions of walkway 402.

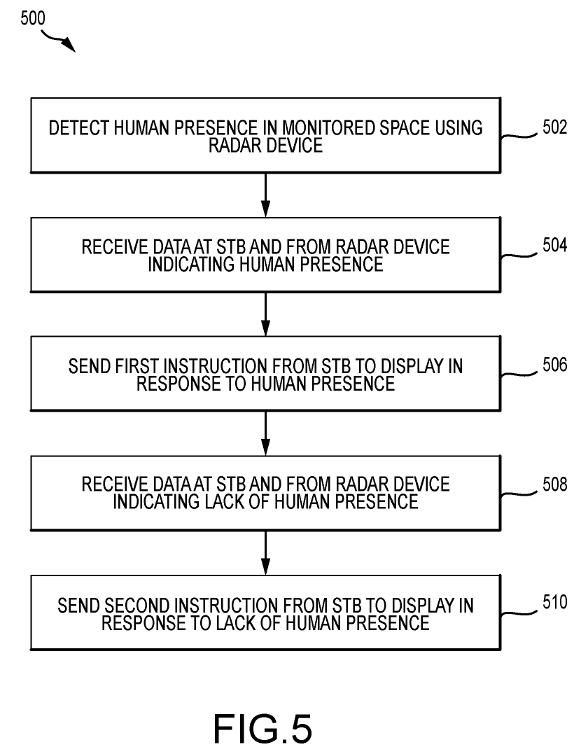

Referring now to FIG. 5, an example process 500 for controlling an electronic device is shown, in accordance with various embodiments. The process of FIG. 5 can be performed using system 100 of FIG. 1A, for example, though other embodiments could be configured differently. Process 500 can include detecting human presence in a monitored space using a radar device (Block 502). Radar device 104 (of FIG. 1A) can be used to detect human presence in room 102 (of FIG. 1A), for example. Radar device 104 can transmit or send data to computing device 105 (e.g., an STB) that indicates human presence in room 102. In some embodiments, radar device 104 can transmit raw data to computing device 105 (e.g., the STB) for analysis, though in various embodiments radar device 104 can process its data to identify human detection and transmit a signal indicating human presence is detected. In a billboard embodiments, such as that of FIG. 3, radar device 304 can detect human presence in the form of an oncoming automobile. Human presence can be detected using the various devices or techniques described herein.

In various embodiments, computing device 105 (e.g., an STB) can receive data from radar device 104 indicating human presence (Block 504) in room 102. A first instruction can be sent from computing device 105 to a connected display in response to the human presence (Block 506). The instruction can include turning the display on, adjusting the display configuration, increasing the volume of an audio source associated with the display, or otherwise controlling the display.

In response to radar device 104 ceases detecting human presence, computing device 105 can receive data indicating a lack of human presence from radar device 104 (Block 508). A second instruction can be sent from computing device 105 to the connected display in response to the lack of human presence (Block 510). The instruction can include turning the display off, adjusting the display configuration, decreasing the volume of an audio source associated with the display, or otherwise controlling the display.

Aspects of the present disclosure tend to improve device efficiency by enabling automated on/off control based on human presence or lack thereof. Light pollution can be reduced in outdoor embodiments by turning off bright billboards when no vehicles or people are nearby. Timing-based activities like making coffee can be automated using the additional input of human presence or absence in conjunction with time settings to optimize performance.

Benefits, other advantages, and solutions to problems have been described herein with regard to specific embodiments. Furthermore, the connecting lines shown in the various figures contained herein are intended to represent example functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process, comprising:
monitoring a location with a radar device;
detecting a human presence in the monitored location using the radar device;
transmitting, from the radar device and to a playback device, first data indicating the human presence in the monitored location;
sending a first instruction from the playback device to a display in response to the human presence;
detecting a lack of the human presence in the monitored location using the radar device;
transmitting, from the radar device and to the playback device, second data indicating the lack of human presence in the monitored location; and
sending a second instruction from the playback device to the display in response to the lack of human presence.

2. The automated process of claim 1, wherein the first instruction comprises an instruction to turn on the display.

3. The automated process of claim 1, wherein the second instruction comprises an instruction to turn off the display.

4. The automated process of claim 1, wherein the playback device comprises a set-top box.

5. The automated process of claim 1, wherein the display comprises a billboard.

6. The automated process of claim 1, wherein the radar device comprises a 24- GHz wavelength (mmWave) device.

7. The automated process of claim 1, wherein the radar device transmits electromagnetic waves and receives reflections of the electromagnetic waves to monitor the location.

8. The automated process of claim 1, further comprising:
detecting a gesture in the monitored location using the radar device;
transmitting, from the radar device and to the playback device, third data indicating detection of the gesture in the monitored location; and
sending a third instruction from the playback device to the display to adjust a playback volume in response to the gesture.

9. An automated process, comprising:
monitoring a road with a radar device;
detecting, by the radar device, a presence of an automobile moving towards a billboard on the monitored road;
transmitting, from the radar device and to a computing device, first data indicating the presence of the automobile moving towards the billboard on the monitored road; and
changing, by the computing device, a state of the billboard in response to receiving the first data.

10. The automated process of claim 9, wherein the computing device changes the state of the billboard to illuminated in response to receiving the first data.

11. The automated process of claim 9, further comprising:
detecting, by the radar device, a second automobile moving away from the billboard on the monitored road;
transmitting, from the radar device and to the computing device, second data indicating the second automobile is moving away from the billboard on the monitored road; and
changing, by the computing device, the state of the billboard in response to receiving the second data.

12. The automated process of claim 9, further comprising:
detecting, by the radar device, the automobile has left a field of view (FOV);
transmitting, from the radar device and to the computing device, second data indicating the automobile has left the field of view; and
changing, by the computing device, the state of the billboard in response to receiving the second data.

13. The automated process of claim 12, wherein changing the state of the billboard in response to receiving the second data comprises darkening the billboard.

14. The automated process of claim 9, further comprising selecting a screen for display on the billboard in response to a detected speed of the automobile moving towards the billboard.

15. An automated process, comprising:
monitoring a location with a first radar device having a first field of view (FOV) oriented towards the location and a second radar device having a second FOV oriented towards the location;
detecting a human presence in the first FOV using the first radar device;
transmitting, from the first radar device, first data indicating the human presence in the first FOV;
sending a first instruction to a first display in response to the human presence in the first FOV;
detecting a lack of human presence in the first FOV and the human presence in the second FOV;
transmitting, from the first radar device, second data indicating the lack of human presence in the first FOV;
sending a second instruction to the first display in response to the lack of human presence in the first FOV;
transmitting, from the second radar device, third data indicating the human presence in the second FOV; and
sending a third instruction to a second display in response to the human presence in the second FOV.

16. The automated process of claim 15, wherein the first FOV penetrates a wall to detect the human presence in the monitored location.

17. The automated process of claim 15, wherein the second FOV is oriented downward and comprises a beamwidth from 5 degrees to 30 degrees.

18. The automated process of claim 15, wherein the monitored location comprises a walkway.

19. The automated process of claim 18, wherein a first portion of the walkway monitored by the first FOV is adjacent a second portion of the walkway monitored by the second FOV.

20. The automated process of claim 15, wherein the first FOV overlaps with the second FOV.
